(19) United States
(12) Patent Application Publication
(10) Pub. No.: US 2024/0016193 A1
(43) Pub. Date: Jan. 18, 2024

(54) METHOD FOR SELECTIVELY SEPARATING AT LEAST ONE ORGANIC SUBSTANCE COMPRISING AT LEAST ONE APOLAR GROUP, AND USE OF SAID SUBSTANCE IN A FOOD, LUXURY FOOD, COSMETIC, OR PHARMACEUTICAL PRODUCT

(71) Applicant: Döhler GmbH, Darmstadt (DE)

(72) Inventors: Agostino BIAFORA, Lampertheim (DE); Dominik BÜTTNER, Neu-Isenburg (DE); Axel KALTENBRUNNER, Wiesbaden (DE); Dominik MISSIKIEWITSCH, Birkenheide (DE); Jan STIELER, Frankfurt (DE)

(73) Assignee: Döhler GmbH, Darmstadt (DE)

(21) Appl. No.: 18/037,104

(22) PCT Filed: Nov. 16, 2021
(86) PCT No.: PCT/EP2021/081893

§ 371 Date: May 16, 2023

(30) Foreign Application Priority Data
Nov. 17, 2020 (DE) 10 2020 130 250.9
Dec. 15, 2020 (DE) 10 2020 133 525.3
May 4, 2021 (DE) 10 2021 002 339.0

(51) Int. Cl. A23L 27/10; A23L 2/56; A23L 27/12

(52) U.S. Cl. CPC A23L 27/11; A23L 27/115; A23L 2/56; A23L 27/12

(57) ABSTRACT

A method for selectively separating at least one apolar organic substance, comprises: (a) providing a starting mixture (10) which contains at least one organic substance comprising at least one apolar group and optionally a solvent; (b) bringing the starting mixture into contact with at least one cyclodextrin to obtain a cyclodextrin-aromatic substance complex; and optionally (c) separating the complex from the liquid phase; and (d) treating the separated complex, in particular enzymatically, and optionally filtering the resulting mixture, whereby a composition loaded with at least one organic substance comprising at least one apolar group is obtained. The invention also relates to a composition loaded with at least one organic substance comprising at least one apolar group, and to the use of this composition in order to introduce at least one apolar organic substance into a food, luxury food, cosmetic product, or pharmaceutical product.

### CROSS-REFERENCE TO RELATED APPLICATION

This application is a national stage application, filed under 35 U.S.C. § 371, of International Patent Application No. PCT/EP2021/081893, filed on 16 Nov. 2021, which claims the benefit of German Patent Applications No. 10 2020 130 250.9, filed 17 Nov. 2020, No. 10 2020 133 525.3, filed 15 Dec. 2020, and No. 10 2021 002 339.0, filed 4 May 2021.

### TECHNICAL FIELD

The invention relates to a method for selectively separating an organic substance comprising at least one apolar group, to a composition which comprises at least one organic substance comprising at least one apolar group, and to a use of this selectively separated organic substance in a food product, luxury food product, cosmetic product, or pharmaceutical product.

### BACKGROUND

The increasing awareness of the population for a healthy lifestyle promotes the sale of non-alcoholic beverages such as sparkling wines (champagne), lemonades or beers. This requires the search for new manufacturing techniques that make it possible to produce beverages and foods not only with an enjoyable taste and a pleasant smell, but also completely without the use of ethanol.

According to the European Food Information Regulation (LMIV), the obligation to label alcohol only begins at 1.2 vol %. The designation “alcohol-free” does not necessarily mean “without alcohol”. For example, beer and wine advertised as “alcohol-free” may contain a maximum of 0.5 vol % of alcohol. If another beverage (other than wine or beer) is advertised as “alcohol-free” it must actually contain no alcohol at all, i.e. the alcohol content is 0.0 vol %; otherwise, the labeling “alcohol-free” is considered misleading and deceptive to consumers. As used herein, the term “alcohol” refers to ethanol.

Important components of food, but also of luxury foods, cosmetic products and pharmaceutical products are obtained by extraction processes with the help of solvents, often using ethanol. However, the components obtained in this way can contain ethanol residues, so that products containing such components are not “alcohol-free”.

Components obtainable by extraction in ethanol that are of interest in the present context include, besides volatile aromatic substances, non-volatile aromatic substances such as bitter substances, oil, fat and/or wax fractions, colorants, and adhesives, from plant-based and/or animal-based starting materials and from other natural sources, for example aromatic substances derived from microorganisms or fungi and/or of synthetic origin.

These substances have at least one apolar group in the molecule, so they can be either apolar or amphiphilic. In the following, these substances are also collectively subsumed under the term “apolar organic substance”, for short, and sometimes abbreviated to “AOS” for better readability.

For many years, there has been great interest in technologies for recovering aromatic substances in particular from dealcoholization and/or concentration processes of such products as beer/wine etc. or from juices, or for removing undesirable substances such as bitter substances from citrus juices, but also for recovering or removing apolar organic substances from cosmetics and pharmaceuticals, and the extracts obtained in this way can be used for alcohol-free re-aromatization, i.e. flavoring, of products or in other ways, for example as a coating agent in the case of waxes.

In the literature, four basic separation processes are described for the recovery of desirable and the removal of undesirable apolar organic substances, in particular aromatic substances which are dissolved in liquids such as water or ethanol: (1) Liquid/liquid extraction with organic solvents, in which the pure substances or the desired fraction is/are finally obtained by evaporation of the solvent used. (2) Rectification of the AOS or aroma-containing liquid. (3) Sorption processes in which apolar aromatic substances from the liquid phase are enriched in a solid phase. (4) Precipitation and crystallization of solid aroma components. (5) Direct extraction with supercritical gases, percolation. For fat, oil and wax fractions from plant-based or animal-based starting material, steam distillation and mechanical processes such as pressing are also applicable.

### SUMMARY

Although extraction has a wide range of applications, the use of large quantities of organic, often chlorinated solvents is highly questionable from an environmental and sustainability point of view. Furthermore, thermally unstable substances can be irreversibly destroyed during evaporation of the solvent. The recovery of, for example, aromatic substances from an ethanolic extract by liquid/liquid extraction is also difficult because ethanol itself is soluble in a variety of organic solvents. Direct re-aromatization with an ethanolic extract is ruled out because the end product would not satisfy the description “without alcohol” (i.e. alcohol content of 0.0 vol %).

Rectification does not allow to selectively remove ethanol or water, since usually azeotropes will be formed with the aromatic substances contained in the extract. Moreover, thermally unstable aroma-imparting components can be irreversibly destroyed.

In the case of sorption processes, the desired enriched substances are re-eluted with apolar media. Ethanol is often used as the eluent, especially in the food industry, which renders the extract unusable for 0.0 vol % applications. Carbon dioxide is also used as a further eluent. EP 3063260 describes a process for extracting two or more fractions from hop oil by treating the hop oil loaded on an adsorbent carrier first with liquid carbon dioxide to separate the first fraction and then with supercritical carbon dioxide to separate the second fraction. The other fractions can be separated when the supercritical carbon dioxide is combined with a co-solvent. While elution with liquid/supercritical carbon dioxide avoids the previously mentioned undesirable use of alcohols, there are high losses in yield when the gas is vented. The construction and operation of a CO2 extraction plant is expensive and has specific safety requirements.

Mechanical processes such as pressing are primarily used in the field of oil extraction and do not require any solvents. However, these processes are not universally applicable for the recovery of all apolar organic substances, especially all oils and waxes from plants.

The object is therefore to provide a method for selectively obtaining at least one apolar organic substance, in particular at least one aromatic substance, preferably from a natural source, such as plant-based or animal-based products, which makes it possible to use the obtained substances in food, luxury food, cosmetic products and/or pharmaceutical products which can be labeled “without alcohol”. Such products should in particular meet the quality requirements for the designation “FTNS” (“From the named source”). The objective is to enable so-called “clean label” products. A further object of the invention is to allow to selectively obtain non-volatile aromatic substances, such as bitter substances, as well as to selectively obtain oil, fat and/or wax fractions from plant-based and/or animal-based starting materials.

From the prior art, a number of processes are known in which cyclodextrins are used to remove undesirable substances from food systems. Cyclodextrins are water-soluble, toxicologically and environmentally harmless. For example, cyclodextrins are used to remove cholesterol from butter (AU 638531B2) or from eggs (EP326469A, EP475451B1). Such removal processes usually consist of two stages: first, cyclodextrin is mixed with the food system to form a complex between the cyclodextrin and the undesirable substance (guest-host complex); and subsequently this complex is removed from the food system. The cyclodextrin can be released from the complex again (decomplexation) by, for example, treatment with hot water or alcohol (40-100° C.) and can then be reused in the removal process.

The use of cyclodextrins in the previously known extraction of aromatic substances has the disadvantage that the solvent used for decomplexation must be used in larger volumes and heated, which leads to a dilution of the aroma concentration and also causes additional technical complexity and high costs. If ethanol is to be used as a solvent for the decomplexation, another problem will arise in addition to the dilution of the aroma concentration, which is associated with the fact that this ethanol cannot be removed again without affecting the flavoring profile.

Surprisingly, the inventors have found that cyclodextrins in aqueous and in alcoholic media can reversibly take up in their cavity such components in particular for food, which can be obtained by extraction in ethanol, such as for example aromatic substances, bitter substances, oils, fats and waxes, adhesives and colorants.

Such components have at least one apolar group, i.e. they can be either apolar or amphiphilic. An amphiphilic component has at least one polar part in addition to at least one apolar part. Organic substances comprising at least one apolar group will be referred to as “apolar organic substances” below, i.e. even if they also have a polar part and are in particular amphiphilic. This term will sometimes be abbreviated as “AOS”. The organic substances obtainable by extraction in ethanol and comprising at least one apolar group within the meaning of the invention are more hydrophobic in water than ethanol.

The invention thus provided a possibility to selectively transfer apolar organic substances from a starting mixture into a complex consisting of cyclodextrin and the apolar organic substance, by choosing a suitable cyclodextrin.

The invention thus achieves the objects stated before in a very simple manner by a method and a composition as described and claimed.

The invention provides a method for selectively separating at least one organic substance which comprises at least one apolar group (AOS) and/or at least one or more aromatic substances, comprising:
(a) providing a starting mixture which contains at least one organic substance comprising at least one apolar group (AOS) and/or at least one or more aromatic substances and optionally at least one solvent,
(b) bringing the starting mixture into contact with at least one cyclodextrin, wherein at least one solvent is added in step (a) and/or in step (b) and/or following step (b), in particular water,
and wherein at least one cyclodextrin-AOS complex and/or at least one cyclodextrin-aromatic substance complex in a liquid, in particular an aqueous phase is obtained as a result of the bringing into contact of the at least one cyclodextrin with the at least one organic substance comprising at least one apolar group and/or at least one or more aromatic substances of the starting mixture.

The terms “the cyclodextrin” or “a cyclodextrin” are understood to mean the entirety of the molecules of cyclodextrin in the respective material system, for example in the starting mixture or in the liquid phase. This applies accordingly to the expression “the cyclodextrin-AOS complex” or “a cyclodextrin-AOS complex”.

The method according to the invention permits to obtain a composition loaded with at least one organic substance that comprises at least one apolar group such as, for example, an aromatic substance or bitter substance. This provides for reversible protection of, for example, thermally unstable substances, which can be removed as soon as this is no longer required.

Depending on the material system in which the at least one apolar organic substance is present in the starting mixture, it is not necessary to add any solvents or further solvents in order to be able to carry out the method of the invention. For example, the starting mixture may already be a solution per se, or, once cyclodextrins dissolved in water have been added in step (b), may then contain sufficient solvent in the form of this water.

The quality of complex formation can be influenced by adjusting the solvent content, in particular the water content and/or the ethanol content, of the starting mixture. The invention therefore offers the option of dosing in at least one solvent in step (a) and/or in step (b) and/or following step (b), depending on the application case. In this case, a person skilled in the art will adjust the solvent content such that the quality of complex formation is optimized for the application. The choice of the cyclodextrin, the temperature and/or the energy input during the complexing, for example by adjusting the stirrer speed, also offer possibilities of influencing the quality of complex formation.

The conditions for complex formation can be adapted to the apolar organic substances to be separated within the scope of the invention. In particular, it is possible within the scope of the invention to adjust the extraction conditions in such a way that, for example, bittering agents can be selectively complexed and isolated, or can else left untouched.

In an advantageous embodiment of the invention, it is contemplated for this purpose, in step (a) and/or in step (b) and/or following step (b), to adjust a water content so as to range from 15 vol % to 35 vol %, preferably from 20 vol % to 30 vol %, in particular by adding water, and/or to adjust an ethanol content so as to be at least 40 vol %, preferably to an ethanol content in the range from 40 vol % to 60 vol %, in particular by adding ethanol.

Ethanol-containing extracts of apolar organic substances, in particular of aromatic substances and/or bitter substances, are excellently suited for being used in flavorings to be added to food, luxury food, cosmetics or pharmaceutical products, since they have a natural complex flavor profile that is very similar to that of the starting material. By adjusting the water and/or ethanol contents during complexation of the apolar organic substance using cyclodextrin, the invention makes it possible to obtain this complexity after dealcoholization, for an alcohol-free product.

In the course of process optimization it has been found that dilution with water to between 15 vol % and 35 vol %, preferably to the range from 20 vol % to 30 vol %, significantly enhances the complexation quality of the cyclodextrins for volatile aroma or flavor constituents. However, depending on the substance system, a surprising result of the addition of water might be that non-volatile aroma or flavor constituents such as bitter substances are not complexed any more. So, the natural aroma profile of the extract is altered. Surprisingly, it was found within the context of the invention, that the complexing of bitter substances can still be achieved with an ethanol content of the liquid phase of at least 40 vol % during the complex formation with cyclodextrin.

The invention thus makes it possible to obtain the characteristic aroma or flavor profile from an ethanolic extract which, in addition to volatile aroma substances also contains non-volatile aroma substances such as bitter substances. The invention thus also offers the possibility of selectively removing non-volatile aromatic substances such as bitter substances from an extract containing apolar organic substances, namely under conditions that are unfavorable for their complexation, in particular an ethanol content below 40 vol %.

Although the use of cyclodextrins (CD) in food systems has been known, it has never been used, according to the knowledge of the inventors, for selectively obtaining aromatic substances or other organic substances that have at least one apolar group. The invention thus provides a method which uses cyclodextrins for obtaining alcohol-free (i.e. ethanol-free) declaration-free FTNS (“from the named source”) aromatic substances or bitter substances from aqueous but also (and especially) from ethanolic extracts.

The invention thus provides a method that allows to separate/obtain organic substances which comprise at least one apolar group and/or at least one aromatic substance or a plurality of aromatic substances from an aqueous or ethanolic or other extract in a concentrated form with the help of cyclodextrins, while reducing the technical complexity (and consumption of solvents), and while allowing the whole process to be implemented at moderate temperatures. The so obtained apolar organic substances such as aromatic substances are suitable for use in food, luxury foods, cosmetic products and/or pharmaceutical products that can be labeled “without alcohol”.

With the invention, a process was found which also makes it possible to selectively obtain oil, fat and/or wax fractions, in particular from plant-based and/or animal-based starting materials. Cyclodextrin has proven to be a suitable adjuvant for this purpose in a surprisingly simple manner, as it is both water-soluble and able to bind to the target substances. The target substance can be removed again from the cyclodextrin-AOS complex without further use of solvents.

The invention allows to obtain, through extraction from the starting mixture using cyclodextrins, all those organic substances comprising at least one apolar group, which are hydrophobic enough to react, as a guest, with alpha- and/or beta- and/or gamma- and/or delta-cyclodextrin as a host to form a complex. In other words, the respective organic substance comprising at least one apolar group is hydrophobic enough to pass from a solution into the cavity of alpha- and/or beta- and/or gamma- and/or delta-cyclodextrin. In the context of the invention, it is not always necessary that the entire apolar substance is complexed into the cavity of the cyclodextrin. For example, in the case of fats and organic acids, it is essentially only the hydrophobic part of the substance that is complexed into the cavity of the cyclodextrin. According to a model conception, the polar part of the substance will protrude from the cavity. In the case of amphiphilic substances, the hydrophobic part will also be accommodated in the cavity, and the hydrophilic part will remain untouched, so to speak.

The method according to the invention avoids to expose the apolar organic substances to a high thermal load. To this end, it is intended according to the invention to perform the method at maximum temperatures in the range between at least 40° C. and at most 70° C., preferably at a temperature of at least 40° C. and not more than 55° C. These temperatures relate in particular to step (d), which will be explained further below. In step (b), the temperatures are preferably lower, in particular in the range from 4° C. to 10° C., preferably at 6° C.

The invention thereby offers the advantage that it can be used for different fields of application, since the at least one organic substance with at least one apolar group can be selected from the group comprising
secondary metabolites,
phytochemicals, in particular secondary plant substances,
volatile aromatic substances,
non-volatile aromatic substances such as, for example, bitter substances,
colorants,
oil, fat and/or wax fractions,
adhesives,
in particular of natural origin, preferably from plant-based and/or animal-based starting materials,
as well as mixtures of at least two of the substances mentioned.

Of particular interest are natural aromatic substances here, including those obtained from microorganisms or fungi. Phenolic substances can be important for stabilizing colorants.

In an advantageous embodiment of the invention, the method comprises the further step of:
(c) separating the cyclodextrin-AOS complex and/or the cyclodextrin-

aromatic substance complex from the liquid phase, in particular from the solvent.

This allows the (still complexed) apolar organic substance, in particular the aromatic substance, to be concentrated. The separation of the cyclodextrin-AOS complex and/or of the cyclodextrin-aromatic substance complex from the liquid phase results in obtaining a separated solid phase which contains at least the cyclodextrin-AOS complex and/or the cyclodextrin-aromatic substance complex. The liquid phase contains water and solvents, in particular ethanol, with which the apolar organic substance such as at least one aromatic substance was provided in the starting mixture and/or which was added during the method according to the invention.

What is retained after step (c) is a substantially solvent-free solid. “Substantially solvent-free” means in particular that solvents such as water and/or ethanol, for example, might be adsorbed on the solid phase, but are no longer freely present in the solid phase. Depending on the application case, the separating of water in step (c) also allows to separate undesirable components of the starting mixture from the filter cake, comparable to the function of a washing step.

The separation of water, for example, but also of other liquids, from the solid phase, in particular from the filter cake, can be supported by drying within the scope of the invention. In a simple implementation, compressed air can be passed through the separated solid phase, for example in the form of a filter cake, towards the filter layer, in particular at a pressure of 2 bar. An inert gas can also be used instead of compressed air.

Known methods for removing alcohol by using evaporators or by reverse osmosis have the effect that, on the one hand, other important, in particular volatile aromatic substances which are decisive for the characteristic taste of the extract are also removed together with the ethanol. On the other hand, thermally unstable substances can be destroyed, or undesirable alterations in taste can be caused. The method described in the invention allows to remove the ethanol from the extract with high selectivity. The complexity of the extract is preserved by complexing both volatile and non-volatile aromatic components equally.

In a further advantageous embodiment of the invention, the method comprises the further step of
(d) treating the in particular separated cyclodextrin-AOS complex and/or the cyclodextrin-aromatic substance complex enzymatically and/or with organisms selected from the group comprising such yeasts, fungi and mixtures thereof which are capable of degrading cyclodextrin, to obtain a composition loaded with at least one organic substance comprising at least one apolar group (AOS) and/or with at least one aromatic substance.

Surprisingly, it has been found that the enzymatic treatment decomposes not only free cyclodextrins, but also cyclodextrins that are bound in a complex with at least one apolar organic substance such as an aromatic substance, and thereby enriches the apolar organic substance, in the example the aromatic substance (without impairment) in the obtained composition.

In addition or as an alternative to a treatment with the enzymes that will be described in more detail further below, this degradation of the cyclodextrin and thus the release of the apolar organic substance from the complex can also be achieved, within the scope of the invention, by using organisms from the group that includes yeasts, fungi and mixtures thereof which are capable of degrading cyclodextrin.

The treatment of the cyclodextrin-AOS complex and/or of the cyclodextrin-aromatic substance complex to obtain the apolar organic substance can be supported with a further step of
d1) diluting with water the cyclodextrin-AOS complex and/or the cyclodextrin-aromatic substance complex separated in step (c) prior to the in particular enzymatic treatment in step (d).

In particular in the case of a preceding step (c) for the separation of water as described above, the water added in step (d1) will then be free of constituents that are undesirable for enzymation.

In an advantageous further embodiment of the invention it is also possible to adjust the pH value for the enzymation in coordination with the employed enzymes, for example to a value in the acidic range, in particular to a pH of 4.5. Within the scope of the invention, the activity of the enzyme can be influenced by adjusting the pH value. When different cyclodextrins are used, this effect can be exploited to first degrade one type of cyclodextrin by adjusting the pH and to then change the pH to degrade another cyclodextrin using the same enzyme.

Advantages of the method according to the invention will now be described using the example of aromatic substances as the apolar organic substance. These advantages also apply to the other apolar organic substances mentioned above: The method of the invention makes it possible to obtain, from a diluted starting mixture, the composition in which aromatic substances are present in a concentrated form. The separation can be carried out gently and completely. Furthermore, thanks to this method it is possible to obtain, from starting mixtures which even may have a very high alcohol content (namely up to 80 vol %), flavor-loaded compositions that can be used in foods, luxury foods, cosmetic products and/or pharmaceutical products which can be labeled “without alcohol.

Since the method according to the invention can be carried out at a temperature that is not higher than 55° C. or even not higher than room temperature, it allows to obtain aromatic substances that are highly volatile and moderately volatile (i.e.

with an evaporation number of less than 10 or between 35 and 10, respectively), and/or which are thermally unstable. A further advantage of the method according to the invention is that the α-, β- and γ-cyclodextrins which are used can in part be selectively hydrolyzed with different amylases, which allows for a cascading release of aromatic substances. These points will be discussed in more detail further below.

According to a further embodiment of the invention it is contemplated to perform step (d) in such a way that the cyclodextrin concentration in the composition that is loaded with at least one apolar organic substance (AOS), in particular with at least one, is less than 0.5 wt %, preferably less than 0.1 wt %. Such a low content of cyclodextrin has not impact on the use of the obtained apolar organic substance (AOS).

The cyclodextrin concentration can be adjusted in relation to the total mass of the composition that represents the end product in the selected embodiment of the method according to the invention. For example, after steps (a), (b), (c), and (d) have been carried out on an aqueous aromatic substance solution, this composition may be a composition consisting of water, aromatic substance, degradation products of the cyclodextrin and enzyme, and residues of cyclodextrin with a content of less than 0.1 wt %. If constituents such as water and enzymes are removed in further method steps, this allows to carry out the enzymatic treatment in such a way that the cyclodextrin concentration is further reduced and will therefore be less than 0.1 wt % in the water- and enzyme-free product.

The adjustment of the cyclodextrin concentration can be promoted by separating out constituent that are undesirable for the final product, which may include non-degraded cyclodextrin-AOS complexes. To this end, according to a further advantageous embodiment of the invention, the method comprises a further step of
(e) filtering the mixture resulting from the in particular enzymatic treatment of the cyclodextrin-AOS complex and/or the cyclodextrin-aromatic substance complex to obtain a composition loaded with at least one organic substance comprising at least one apolar group (AOS).

### Step (a)

In the present invention, “aromatic substance” refers to an organic substance which is volatile in particular at room temperature, and which causes or modifies olfactory and taste perceptions. Aromatic substances are often alcohols, acids, esters, lactones, aldehydes, ketones, acetals, ketals, ethers, epoxides and their analogous sulfur compounds; oxygen heterocycles, nitrogen heterocycles, and sulfur heterocycles, heteroaromatics (e.g. alkylpyrazines), amines and amides; simple or complex, saturated and unsaturated, aliphatic and cycloaliphatic compounds, aromatics and terpenes, etc.. The principle types of aromatic substances are natural, nature-identical, and artificial aromatic substances. In the context of the present invention, preference is given to the so-called natural aromatic substances for which the starting material is of plant-based or animal origin. The starting material of animal origin is for example honey, milk, meat, bones, and body fluids. The starting material of plant-based origin includes plants or plants parts such as flowers, buds, leaves, stems, stalks, bark, roots, tubers, bulbs, rhizomes, fruits, nuts, berries and seeds, fruits, and vegetables. These starting materials may be provided, for example, in fresh, cooked, sprouted, dried, fermented form, or in a form prepared for consumption as a food or luxury food (such as beer, wine, sparkling wine, spirits such as whiskey, etc.). These starting materials can either be used directly, as the starting mixture in the method according to the invention, or these starting materials may be processed in at least one process known to those skilled in the art prior to being used as the starting mixture. Such processes include, for example, dissolving, dispersing, purifying, mashing, soaking, fermentation and/or separation processes such as extraction, filtration, etc. Examples of plants that provide ethanolic extracts with bitter substances are gentian, chiretta and wormwood.

In addition to such “aromatic substances”, the starting mixture may also contain other constituents of the starting material of plant-based or animal origin. In particular, the starting mixture may contain one or more apolar organic substances, which also include non-volatile aromatic substances such as, for example, bitter substances, oil, fat and/or wax fractions, in particular from plant-based and/or animal starting materials, as well as mixtures of at least two of the substances mentioned.

Within the scope of the invention, the starting mixture may be provided in the form of a solid or liquid dispersion, in particular in the form of a powder or a solution and/or a suspension and/or an emulsion. In principle, the starting mixture can contain any solvent in which the apolar organic substances to be separated will dissolve and which can be easily accommodated in the cavity or displaced from the cavity of the cyclodextrin molecule, comprising at least one substance to be separated. Solvents that can be used within the scope of the invention in step (a) and/or in step (b) and/or following step (b) include, for example, water, C₁-C₄ alcohols, diethyl ether, acetone, etc. or mixtures thereof. A solvent selected from the group comprising water, ethanol or mixtures thereof is preferably used. It is also possible to add a solvent in step (a) as part of the provisioning of the starting mixture. For example, ethanol- and/or water-containing starting mixtures can also be extracted directly by using cyclodextrin according to the invention, depending on which substances are to be separated.

In one embodiment of the invention, at least one of the aforementioned solvents can be added in step (b) in addition to having been added in step (a).

The preferred solvent content is less than 100 wt %. A person skilled in the art will select the solvent content and the mixing ratio of two or more solvents in accordance with the solubility of the aromatic substance(s) to be separated, the effectiveness of complex formation, as well as by taking into account the economics of the process. A starting mixture in which the at least one apolar organic substance, in particular the one or more aromatic substance(s), is/are dissolved in a minimal amount of solvent is particularly preferred.

The higher the solvent content, the higher is the solubility of an aromatic substance to be separated and of a cyclodextrin used, which increases the rate of complex formation. However, excessively dilute solutions should be avoided, as the process becomes uneconomical and, moreover, the probability of contact and interaction of molecules of aromatic substances with cyclodextrin becomes too low. According to one model conception, these relationships are due to the fact that at higher concentrations of apolar organic substance, complexes of this substance with cyclodextrin will be formed preferentially due to the driving gradient. In the case of excessive dilution, the driving force for complex formation will no longer be sufficient.

Preference is given to a starting material in a form prepared for consumption as a food or luxury food (e.g. such as beer, wine, sparkling wine, spirits, etc.), which is subjected to an extraction, preferably a solid phase extraction (SPE for short, previously also known as “sorbent extraction”), and the resulting solvent-containing solid phase extract is used as the starting mixture. Particularly preferred is an ethanol-containing solid phase extract in which the ethanol content may be up to 80 vol % based on the total volume of the solid phase extract. The content of aromatic substance(s) is at least about 0.1 wt %, preferably from 0.5 to 8 wt %, based on the total weight of the solid phase extract.

Seeds of any kind, in particular cereals as well as products obtained from the cereals, such as malt, wort, mash, beer or the like, represent another preferred starting material. Cereals can be selected, for example, from the group comprising barley, wheat, rye, spelt, corn, oats, rice, millet, triticale, and mixtures thereof. This starting material can either be used directly as a starting mixture in the method according to the invention, or can be processed in at least one process known to those skilled in the art (see above). Particularly preferred as starting material is beer wort and/or mash, which is subjected to fermentation, and the fermentate obtained is used as the starting mixture. The content of aromatic substance(s) is at least about 0.01 wt %, preferably from 0.1 to 8 wt %, based on the total weight of the fermentate.

### Step (b)

In step (b) of the method according to the invention, the cyclodextrin-AOS complexes are produced by bringing at least one cyclodextrin into contact with the starting mixture. The components can be mixed either in a powdered state or in a suspension and/or in an emulsion and/or in a solution.

Various processes for the production of guest-host complexes are known, the most commonly applied being the preparation in solvent (coprecipitation and complexation in a suspension “slurry method”) or the kneading method (see, e.g., S. K. et al.// Research Journal of Pharmaceutical, Biological and Chemical Sciences., 2013, Vol. 4, No. 2, pp. 1694-1720).

The invention uses co-precipitation or complexation in a suspension (“slurry method”) in which at least one cyclodextrin is added to an aqueous or ethanol-containing solution or suspension of the starting mixture and precipitating complexes are separated.

“Cyclodextrins” that can be used include a substituted or unsubstituted α-cyclodextrin, at least one substituted or unsubstituted β-cyclodextrin, at least one substituted or unsubstituted γ-cyclodextrin, or at least one substituted or unsubstituted δ-cyclodextrin, or mixtures thereof, preferably substituted or unsubstituted γ-cyclodextrin. Since the use of substituted cyclodextrins may give rise to substances, as degradation products of the optional method step (d) of the enzymatic treatment, which may be undesirable in food and can be removed in a further separation step, the use of unsubstituted cyclodextrins is preferred in such cases.

According to one model conception, gamma-cyclodextrin, when compared to the other cyclodextrins mentioned, provides a good trade-off between its solubility in water and/or ethanol on the one hand, and its cavity size on the other. In addition, particularly good enzymatic degradation was observed, which is explained in the model conception by the fact that the gamma-cyclodextrin scaffold has a certain flexibility due to its size. According to the lock-and-key principle, this molecule can thus be stored particularly well in the active pocket of the enzyme.

Particularly preferred is a mixture consisting of 10 wt % of substituted or unsubstituted β-cyclodextrin and 90 wt % of substituted or unsubstituted γ-cyclodextrin, especially with regard to the separation of the cyclodextrin-AOS complex from the liquid phase resulting from the starting mixture. This will be discussed in more detail further below. The use of a high proportion up to exclusively γ-cyclodextrin is preferred if non-volatile apolar organic substances and in particular bitter substances are to be obtained by the inventive extraction using cyclodextrins. The invention thus also offers the possibility of selectively removing non-volatile aromatic substances, such as bitter substances, from an extract containing organic substances with at least one apolar group through conditions that are unfavorable for their complexation, in particular an ethanol content below 40 vol % and/or the exclusive use of gamma-cyclodextrin.

With a mixture of different cyclodextrins, such as beta-cyclodextrin with gamma-cyclodextrin, it is possible according to the invention to complex bitter substances to an increased extent or almost exclusively in the gamma-cyclodextrin molecules, and other aromatic substances to an increased extent or almost exclusively in the other cyclodextrin molecules. Figuratively speaking, the “guests” look for the most suitable “hosts” for the formation of the complex. In this way, through the quantitative ratio of the various cyclodextrins, it is possible to influence the composition of the removed organic substances comprising at least one apolar group.

Cyclodextrin can be used in the form of a mixture with water, but also in at least one of several other solvents such as glycerol, propylene glycol, dimethyl sulfoxide (DMSO), dimethylformamide (DMF), ethylene glycol. Cyclodextrin in a solid form is preferred, so that cyclodextrin can be easily handled and added to the starting mixture as a solid. Furthermore, with the use of cyclodextrin as a solid, no additional dilution of the starting mixture will be caused by solvent introduced together with the cyclodextrin.

The amounts of cyclodextrin are varied within rather wide limits, but preferably between about 1 and about 100 wt %, more preferably between about 3 and about 50 wt %, most preferably between about 3 and about 20 wt % are used, based on the amount of the starting mixture.

The mixing of at least one cyclodextrin with the starting mixture is achieved using any device known to those skilled in the art, such as a mechanical stirrer, mechanical disperser, ultrasonic disintegrator. The person skilled in the art will choose the parameters of temperature and holding time in coordination with the effectiveness of the complex formation and taking into account the economics of the process.

In general, temperature and holding time can be widely varied. A preferred temperature range is between about 4° C. and about 25° C., preferably in the range from about 4° C. to about 15° C., more preferably in the range from about 4° C. to about 10° C., most preferably at a temperature of about 6° C. The holding time can be up to 5 days, preferably over a duration of 20 minutes to 72 hours, most preferably over a duration of up to 48 hours.

In the context of the invention it has been found that cyclodextrins in aqueous and alcoholic media are able to reversibly accommodate, in their cavity, organic substances which comprise at least one apolar group, and about 60 to 99 wt % of the aromatic substances present in the starting mixture can be selectively complexed, while the remaining constituents of the starting mixture largely remain in the liquid phase. This finding of the reversible accommodation of organic substances comprising at least one apolar group is exploited by the method according to the invention for the efficient selective separation of these substances.

### Step (c)

In step (c), the cyclodextrin-AOS complexes formed in step (b) are separated from the liquid phase. The cyclodextrin-AOS complexes formed are quite stable, which means that the apolar organic substance bound in the complex, such as an aromatic substance, has little tendency to leave the complex or the cavity of the cyclodextrin again. The complexes are therefore stable enough to become concentrated in the aqueous medium by filtration techniques. In principle, they can be separated using any of the processes and techniques commonly used in technology for the separation of solids and liquids, without releasing the guest in the process. Preferred separation techniques for the separation of the cyclodextrin-AOS complex in step (c) are filtration and/or sedimentation and/or centrifugation, particular preference being given to filtration such as, for example, by vacuum, or nanofiltration, or ultrafiltration. Reverse osmosis is another separation process eligible for the separation of the cyclodextrin-AOS complex in step (c).

In a further advantageous embodiment, the method according to the invention comprises a further step of
(c1) allowing to rest, prior to the separating of the cyclodextrin-AOS complex from the liquid phase, wherein the resting phase according to step (c1) is performed in particular over a duration of up to 24 hours, preferably over a duration of up to 12 hours, most preferably over a duration of 2 hours.

Allowing to rest the cyclodextrinated starting mixture in which the cyclodextrin-AOS complex is forming or has formed promotes the separation of the complexes. Surprisingly, it has been found that by allowing it to rest, faster sedimentation and better filtration behavior are achieved. Allowing to rest results in sedimentation, and the sedimentation makes it possible to remove a clear phase essentially free of cyclodextrin-AOS complex from above the sediment containing the cyclodextrin-AOS complex. This reduces the total volume that has to be separated, for example filtered off, in step (c). It is also possible to carry out step (c) through sedimentation alone, by removing the supernatant so as to obtain a phase containing cyclodextrin-AOS complexes.

In solid-liquid separation processes, filter aids are usually used to improve filtration. These can be incorporated into filter plates, filter layers or filter cartridges, or they can be added directly to the suspension to be filtered as a sedimentation aid (diatomaceous earth, cellulose, bentonite or other cationic flocculants). Physically, for example, the sedimentation and thus the separation can be accelerated by using centrifuges. Other processes using filter aids include precoat filtration. The most important example here is diatomaceous earth filtration or filtration with perlites. A filter layer is precedingly washed onto a horizontal or vertical supporting layer. The actual filtration is carried out with constant addition of the filter aid in order to prevent the filter from becoming blocked.

The filter aids ensure the permeability of the filter and thus prevent the filter surface from gradually becoming blocked by the filter cake that builds up, especially in the case of a filter consisting of a filtration layer. The filtrate is usually the desired product and the retentate or the filter cake is discarded.

In the context of the invention, it shall be possible to dispense with the use of the usual filter aids mentioned above, since the cyclodextrin-AOS complex is separated as a filter cake which in this case represents the desired “product” of separation step (c). If the usual filter aids mentioned above were used, these filter aids together with the cyclodextrin complex would form the retentate. The filter aid would have to be separated from the filter cake in a further process step. This is possible within the scope of the invention. However, a significant improvement from an economic, ecological and nutritional point of view is achieved by avoiding the mixing of the end product with filter aids.

Studies on sedimentation behavior and filtration properties of the different cyclodextrins have shown that complexes with β-cyclodextrin are sedimenting faster than similar complexes with γ-cyclodextrin. Moreover, complexes with β-cyclodextrin show better filtration behavior than similar complexes with γ-cyclodextrin, since they agglomerate in such a way that the filter surface is blocked significantly less or almost not at all.

However, products obtained with β-cyclodextrin do not always have positive sensory properties. Flavors obtained with γ-cyclodextrin, on the other hand, are of higher sensory quality, but sediment slowly and block the filter surface very quickly.

Therefore, mixtures of beta-cyclodextrin with other cyclodextrins have been investigated and, surprisingly, it has been found that even the use of relatively small amounts of beta-cyclodextrin, for example 10 wt % of beta-cyclodextrin based on the total mass of cyclodextrins used, can significantly accelerate sedimentation. By adding beta-cyclodextrin to alpha-cyclodextrin and/or gamma-cyclodextrin and/or delta-cyclodextrin, preferably to gamma-cyclodextrin, the invention provides a way of accelerating sedimentation and centrifugation, respectively.

According to one advantageous embodiment it is contemplated for the proportion of beta-cyclodextrin in the total mass of cyclodextrins to be in a range from 0.5 wt % up to 60 wt %, preferably in the range from 2 wt % to 50 wt %, most preferably in the range from 5 wt % to 15 wt %. Thus, within the scope of the invention, the composition of the cyclodextrins can be selected for the respective application with regard to the specific organic substance or substances comprising at least one apolar group to be obtained from a starting mixture and/or with regard to the speed of the separation step.

In combination with 90 wt % of gamma-cyclodextrin, for example, sedimentation was accelerated from one day to 2 hours. An aromatic substance obtained by using a mixture consisting of 10 wt % of beta-cyclodextrin and 90 wt % of gamma-cyclodextrin had the same sensory quality as the corresponding aromatic substance extracted from pure gamma-cyclodextrin.

By way of example, the sedimentation rate was measured using a substance system of an ethanolic beer extract with 60 vol % of ethanol and with a concentration of aromatic substance in the range from 5 to 8 wt %. In this case, all aroma-active components detected in the GC spectrum were summarized under the expression “aromatic substance”. The suspension obtained after complexing, with cyclodextrin-aromatic substance complexes in the ethanolic extract, was simultaneously transferred into identical graduated cylinders. The sediment volumes were read off the scale of the graduated cylinder at 30 min intervals. In this way, the sedimentation behavior of substances complexed in cyclodextrin according to the invention can be determined.

The separation of the cyclodextrin-AOS complex from the liquid phase resulting from the starting mixture can be an important step to increase the yield of organic substance comprising at least one apolar group. For example, if an aromatic substance is to be obtained from an ethanol-containing starting mixture, the efficiency of the subsequent, in particular enzymatic, treatment of the complexes can be influenced through the solid-liquid separation of the cyclodextrin-aromatic substance complexes from the ethanolic medium.

With the solid-liquid separation a filter cake is formed which contains the cyclodextrin-AOS complex. If this filter cake is not “dry” enough, in the case where aromatic substance is separated from an ethanolic medium, the alcohol still present can hinder the subsequent enzymatic degradation of the cyclodextrin complex. Furthermore, in the case of single-layer filtration, the filter cake builds up gradually, which can block the filter layer and make the separation step uneconomical due to time constraints. In such situations, filter aids can prevent the filter cake that builds up from blocking the filter layer.

It was surprising for the inventors to realize that β-cyclodextrin can serve not only as an extraction agent for an apolar organic substance that is complexed as a guest, but also as a filter aid. Beta-cyclodextrin as a filter aid can advantageously remain in the filter cake and in a further step be broken down or degraded enzymatically into substances that are harmless for use in food. Beta-cyclodextrin as a filter aid is thus largely similar to the substances used for complexing the apolar organic substances and has the same chemical and physical properties.

The realization that beta-cyclodextrin, like the gamma-cyclodextrin, binds aromatic substances to itself and also serves as a filter aid was new to the inventors. After beta-cyclodextrin has been used in the method according to the invention as an extraction agent and, moreover, also as a filter aid, the beta-cyclodextrin can be degraded in the context of the invention by using enzymes, whereby the complexed aromatic substances are released again at the same time. The only degradation products of the cyclodextrins are mono-, di-, and oligosaccharides which are usually found in food or luxury food and can therefore remain there. This will be discussed in more detail further below. In this way, the problem of mixing and retention of filter aids in the product as described above is prevented by the invention.

The product thus has the same nutritional purity and quality as when gamma-cyclodextrin alone is used, with significantly improved processability at the same time. Here, quality in particular refers to the sensory quality with respect to the apolar organic substance. In the case of aromatic substances, for example, an excessively high content of beta-cyclodextrin leads to a change in the flavor profile, since some flavor components are preferentially complexed at the expense of others. However, the sweetness from the degradation products of the cyclodextrin is usually negligible when considering the final dosage.

The present invention was tested on the ethanolic beer extract described above. The test included the complexation of aromatic substances in gamma/beta-cyclodextrin mixtures, measurement of the sedimentation rate, drying of the filter cake, enzymatic degradation of cyclodextrins to release the aromatic substance again, analytical determination of the aroma concentration and aroma profile, and sensory evaluation of the samples produced in this way. The concentration of aromatic substance was quantified as the total of all aromatic substances typical for beer using gas chromatography. The amount of residual cyclodextrin was measured by HPLC (high-performance liquid chromatography) using an RI detector. Accordingly, as little as 10 wt % of beta-cyclodextrin in the cyclodextrin mixture used is sufficient to accelerate the sedimentation rate from 1 day to 2 hours. The final product is an aqueous aroma extract of aromatic substances typical for beer, that is concentrated compared to the starting mixture. It was successfully applied at a dosage of 1:1000 to a beer with an alcohol content of 0.0 vol %. The term “successful” means that the addition of the final product causes an aroma profile characteristic for beer. The dosage is low enough so that the ethanol content in the final application is below 0.05 vol %, which can therefore be declared to be a “0.0 vol %” beer. Also, the final product is clear and can therefore readily be used for typically clear beers such as Pils.

The invention thus also relates to the use of beta-cyclodextrin as a filter aid.

The separated liquid phase as obtained by separating the cyclodextrin-AOS complex in step (c) may optionally be re-mixed with at least one cyclodextrin, to maximize yield and, in particular, can be recirculated to step (a).

According to a further embodiment of the invention it is contemplated that, prior to the in particular enzymatic treatment in step (d) which will be explained in more detail below, the cyclodextrin-AOS complex separated in step (c) is diluted with water in a step (d1) until a desired final concentration of one or more aromatic substances or cyclodextrin-AOS complex is reached. In this way, the conditions for the most complete release of the extracted apolar organic substance(s) can be improved.

### Step (d)

In step (d), the solid phase separated in step (c), which contains cyclodextrin-AOS complexes, is subjected to an enzymatic treatment with at least one enzyme selected from the group comprising enzymes with amylase activity, preferably alpha-amylase, most preferably with fungal alpha-amylase, debranching enzymes, in particular pulluanase and/or isoamylase, and mixtures of at least two of these enzymes, in order to hydrolyze the cyclodextrin in these complexes.

The resulting mixture is optionally filtered.

During the targeted enzymation of the host-guest complexes, the ring form of the cyclodextrin is broken, and the target substances which have previously been complexed and optionally enriched are released again without thermal energy. The available alpha-, beta-, gamma-, and delta-cyclodextrins and the complexes formed with these cyclodextrins as a host can be partially selectively hydrolyzed by different enzymes, in particular different amylases. As a result, the invention enables a process design that allows for a cascaded release of apolar organic substances such as aromatic substances.

After step (d), a composition loaded with at least one aromatic substance is obtained. This composition also contains the degradation products of the cyclodextrin, such as mono-, di-, and oligosaccharides. These degradation products are commonly found in food and can therefore remain there or be removed as required.

This in particular enzymatic treatment according to step (d) of the method according to the invention is carried out in the presence of water. In one embodiment of the invention, step (d) is preceded by a step (d1) in which the solid phase separated in step (c) is mixed with water until the desired final concentration of one or more aromatic substances is reached. The final concentration preferably used is at least 100 wt % up to about 3750 wt % of water, based on the total weight of the solid phase separated in step (c).

In one embodiment of the invention, the water added in step (d1) has a temperature in the range from 4 to 80° C., preferably in the range from 20 to 60° C. The pH value can be adjusted in accordance with the enzyme that is used and is preferably at a pH of 3.5 to a pH of 7.5, most preferably 4.5 or in the range from 5.2 to a pH of 5.6.

Subsequently, the obtained aqueous mixture is treated with at least one enzyme selected from the group comprising enzymes with amylase activity, preferably alpha-amylase, most preferably with fungal alpha-amylase, debranching enzymes, in particular pulluanase and/or isoamylase, and mixtures of at least two of the enzymes mentioned, preferably a mixture of two amylases, and enzymes capable of degrading cyclodextrins as a side activity.

By using different enzymes, in particular different amylases, the α-, β-, and/or γ-cyclodextrins used in the complexes can be partially selectively hydrolyzed. This thus enables a process in which the aromatic substances are released in a cascading manner.

Alpha-amylase is particularly preferred, and most preferred for the treatment is fungal alpha-amylase. This fungal alpha-amylase is preferably used alone.

The fungal alpha-amylases used according to the invention are derived from microorganisms such as Aspergillus niger and Aspergillus oryzae. A well-suited commercial product of fungal alpha-amylase is marketed under the name “Fungamyl®” by the company “Novozymes”. Another suitable amylase is marketed under the name “Dextrozyme GA” by the company “Novozymes”.

It is known that enzymes of different origin exhibit different reactivities. The amount of enzyme required for each mixture varies from mixture to mixture and from enzyme to enzyme. The preferred amount of enzyme used to hydrolyze a cyclodextrin in a cyclodextrin-aromatic substance complex depends essentially on the content of the solid phase separated in step (c), which contains cyclodextrin-aromatic substance complex, and may also depend on the activity of the enzyme.

Within the context of the invention it was found that the preferred amount of the at least one enzyme is 5 to 1000 FAU per gram of the solid phase separated in step (c). The unit “FAU” means “fungal alpha-amylase unit” and is a measure for the activity of an alpha-amylase which is used by the company “Novozymes”, for example for the enzyme “Fungamyl®”. More precisely, under standard conditions (substrate: soluble starch, incubation time 7 to 20 min, temperature 37° C., pH 4.7), 1 FAU of an enzyme will degrade 5.26 g of starch in one hour.

Treatment conditions such as temperature and duration can be varied within wide limits, especially in step (d), however, temperatures between about 4 and about 80° C., preferably between about 20 and about 60° C. have been found to be advantageous, and treatment times commonly range from 0.5 to 50 hours. The pH value can be at a pH from 3.5 to 7.5, most preferably at a pH from 5.2 to 5.6. Incubation in a closed vessel is particularly preferred.

After the enzymatic treatment, the maximum final cyclodextrin concentration is about 0.1 wt %, based on the total weight of the aqueous mixture. The amount of cyclodextrin in the mixture is determined using known methods, namely by HPLC.

Furthermore, additional enzymes can be used. For example, suitable debranching enzymes such as pulluanase and/or isoamylase can be used prior to the treatment with at least one amylase and/or in combination with at least one amylase.

In a further embodiment of the invention, the enzyme is inactivated and/or separated from the composition which contains the apolar organic substance that has been released from the cyclodextrin-AOS complex by the enzymatic treatment. For example, propylene glycol (PG) or glycerol can be used for this purpose.

The subject-matter of the present invention furthermore encompasses a composition, in particular produced by a method as described above, comprising
at least one organic substance comprising at least one apolar group, which is selected from the group comprising volatile aromatic substances, non-volatile aromatic substances such as bitter substances, oil, fat and/or wax fractions, colorants and adhesives, in particular from plant-based and/or animal-based starting materials, and mixtures of at least two of the substances mentioned, and
at least one saccharide with a chain length of 6 or 7 or 8 or 9 glucose units, and optionally degradation products of at least one cyclodextrin, in particular glucose and/or maltose.

Within the scope of the invention, in an advantageous simple embodiment, the composition may consist of at least one organic substance comprising at least one apolar group and at least one saccharide with a chain length of 6 or 7 or 8 or 9 glucose units and optionally degradation products of at least one cyclodextrin, in particular glucose and/or or maltose.

In a preferred embodiment of the invention, the composition has an ethanol content of 0.0 vol %.

The composition is preferably an aqueous composition. The composition according to the invention can then be further processed depending on the intended use. For example, it is possible to inactivate at least one enzyme that is included in the composition by heating and/or by changing the pH value or by using PG or glycerol. Depending on the type of at least one apolar organic substance and of the enzymes or organisms used to degrade the cyclodextrin, the apolar organic substance itself may also cause or support inactivation.

The degradation products of at least one cyclodextrin and of the enzyme can be removed from the composition according to the invention by common “downstreaming” processes such as liquid/liquid extraction to obtain the undiluted apolar organic substance, so that the obtained composition can contain only at least one apolar organic substance, in particular at least one aromatic substance, which may be of either animal or plant-based origin. When the solubility for apolar organic substance in water is exceeded, this substance will separate as an oil phase or solid. In this way, the apolar organic substance can additionally be separated from the aqueous sugar-containing phase.

Another possibility for separating the degradation products of at least one cyclodextrin is their oxidation into acids which can subsequently be removed by adsorbers, anion exchangers, or through the formation of chelates.

The invention thus also enables the use of the composition according to the invention, which is loaded with an aromatic substance by way of example, in particular for introducing at least one aromatic substance and/or one organic substance comprising at least one apolar group, which is selected from the group comprising volatile aromatic substances, non-volatile aromatic substances such as bitter substances, oil, fat and/or wax fractions, colorants and adhesives, in particular from plant-based and/or animal-based starting materials, and mixtures of at least two of the substances mentioned, into a food, luxury food, cosmetic product, or pharmaceutical product, preferably into a food or a beverage, most preferably into a food or a luxury food or a beverage or a cosmetic product or a pharmaceutical product having an ethanol content of 0.0 vol %. The invention thus also provides a method for flavoring and/or stabilizing a product that is a food, luxury food, cosmetic product, or pharmaceutical product, in which the composition described above or the composition produced by a method as described above is added to the product to be flavored. Such a product can then advantageously be advertised with the designation “without alcohol” (i.e. alcohol content of 0.0 vol %) and/or with the designation “FTNS”. Depending on the obtained organic substance that comprises at least one apolar group, the invention provides not only a method for flavoring but also a method for stabilizing products, for example with the help of oil, fat and/or wax fractions as a coating or coating constituent and/or with phenolic substances, for example, for color stabilization.

In the method according to the invention for flavoring and/or stabilizing a product, in particular a food, luxury food, cosmetic product or pharmaceutical product, in which the composition according to the invention, in particular produced by the method described above is brought into contact with the product to be flavored and/or stabilized, this “bringing into contact” can be achieved using any process known to those skilled in the art that is suitable for this purpose, preferably mixing. A food or luxury food or cosmetic product or pharmaceutical product containing the composition according to the invention, which was preferably produced by the method as described above, represents a further subject-matter of the invention. Particularly preferred is a food or luxury food or cosmetic product or pharmaceutical product which is a beverage, most preferably beer, and which can be advertised with the designation “without alcohol” (i.e. alcohol content of 0.0 vol %) and/or “FTNS”.

The invention will be explained in more detail with reference to the accompanying drawings and the exemplary embodiments, without however being limited to the respective specific embodiment described. The invention also relates to any combinations of preferred implementations as far as these are not mutually exclusive. The terms “about” or “approximately” when accompanied by a number are meant to include at least values that are higher or lower by 10%, or higher or lower by 5%, and in any case higher or lower by 1%.

### BRIEF DESCRIPTION OF THE DRAWINGS

FIG. 1 is a schematic diagram of a first embodiment of the method according to the invention, using the example of the separation of an aromatic substance from an aqueous solution, for example from a fermentate;

FIG. 2 is a schematic diagram of a second embodiment of the method according to the invention, using the example of the separation of an aromatic substance from an ethanolic extract such as, for example, resulting from an SPE; and

FIG. 3 shows photographs of a comparison test of the sedimentation rate of gamma-cyclodextrin-aromatic substance complex (left), beta-cyclodextrin-aromatic substance complex (middle), and corresponding complexes in a mixture consisting of 10 wt % beta- and 90 wt % gamma-cyclodextrin, based on the total mass of cyclodextrin (right).

### DETAILED DESCRIPTION

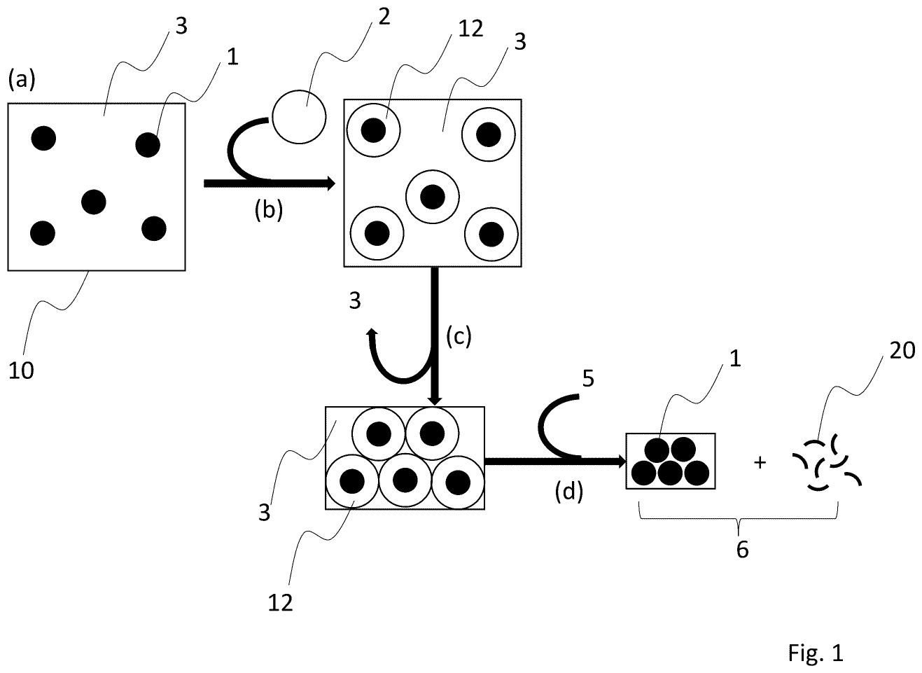

FIG. 1 shows a schematic diagram of an embodiment of the method according to the invention for selectively separating at least one organic substance which comprises at least one apolar group (AOS). First, in a step (a), a starting mixture 10 is provided, which contains an apolar organic substance in the form of an aromatic substance 1 in aqueous solution. Such a water-based aromatic substance 3 may be a fermentate, for example, which may in particular have a low concentration of aromatic substance and optionally contains at least one solvent. In step (b), the starting mixture 10 consisting of aromatic substance 1 in water 3 is brought into contact with at least one cyclodextrin 2. Water is already added in step (a), as a solvent. As a result of the bringing into contact of the at least one cyclodextrin 2 with the at least one apolar organic substance 1 of the starting mixture 10, at least one cyclodextrin-AOS complex 12 is obtained. Due to the formation of the complex, the apolar organic substance in the form of the aromatic substance is extracted from the solvent water 3 of the starting mixture 10. The complexes 12 are present in an aqueous phase.

FIG. 1 also illustrates the optional continuation of the method according to the invention, where in step (c) the cyclodextrin-AOS complex 12 is separated from the liquid phase by removing water 3. Subsequently, in step (d), the aromatic substance 1 is released from the cyclodextrin-AOS complex 12 by enzymatic treatment. What is obtained is a composition 6 loaded with the apolar organic substance, here the aromatic substance 1. It comprises the concentrated aromatic substance 1 and, as a by-product of the enzymatic treatment, saccharides 20.

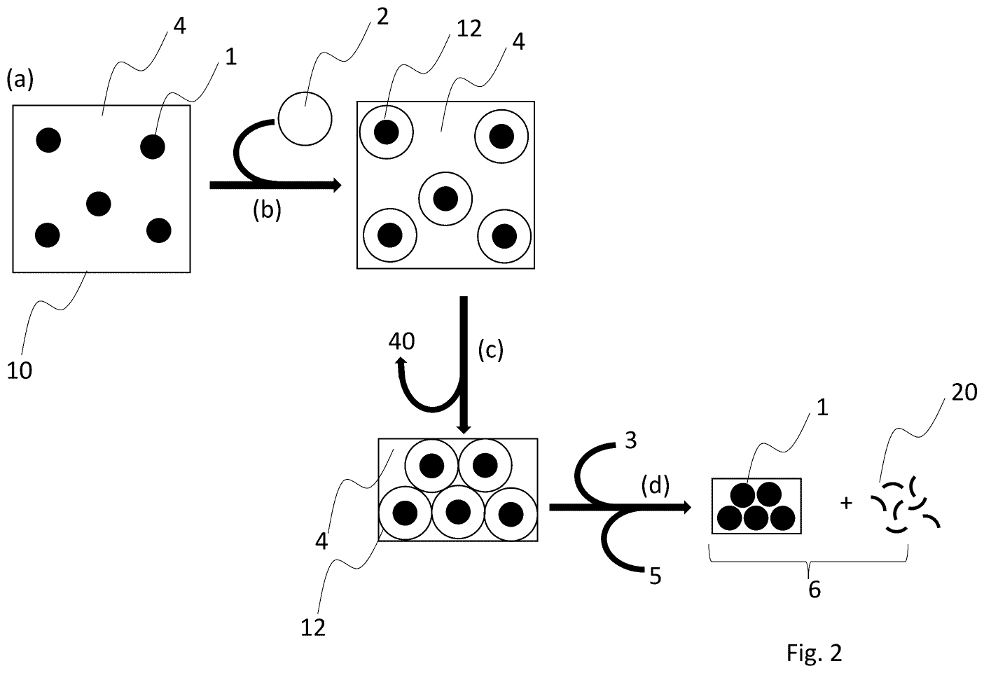

FIG. 2 shows a schematic diagram of a further embodiment of the method according to the invention for selectively separating at least one apolar organic substance (AOS). First, in a step (a), a starting mixture 10 is provided, which contains an ethanolic extract, for example from a solid phase extraction, SPE, in the form of an aromatic substance 1 in an ethanol-containing solution 4 containing 80 vol % of alcohol (ethanol), for example. In step (b), the starting mixture 10 consisting of aromatic substance 1 in ethanolic solution 4 is brought into contact with at least one cyclodextrin 2. As a result of the bringing into contact of the at least one cyclodextrin 2 with the at least one apolar organic substance 1 of the starting mixture 10, at least one cyclodextrin-AOS complex 12 is obtained. Due to the formation of the complex, the apolar organic substance in the form of the aromatic substance is extracted from the ethanol-containing solution 4 of the starting mixture 10. The complexes 12 are present in an aqueous, alcohol-containing phase 4.

FIG. 2 also illustrates the optional continuation of the method according to the invention, where in step (c) the cyclodextrin-AOS complex 12 is separated from the liquid phase by removing ethanol 40. Subsequently, in step (d), the aromatic substance 1 is released from the cyclodextrin-AOS complex 12 by enzymatic treatment. To this end, water 3 is added in step (c) to the solid phase consisting of the complex 12 of cyclodextrin and—in this case—aromatic substance, in order to create suitable conditions for the enzymatic treatment. What is obtained from step (d) is a composition 6 loaded with the apolar organic substance, here the aromatic substance 1. It comprises the concentrated aromatic substance 1 and, as a by-product of the enzymatic treatment, saccharides 20. Depending on process control and depending on which ethanol concentrations can be tolerated in the composition for the respective application case, the composition may contain up to 10 vol % of ethanol, for example.

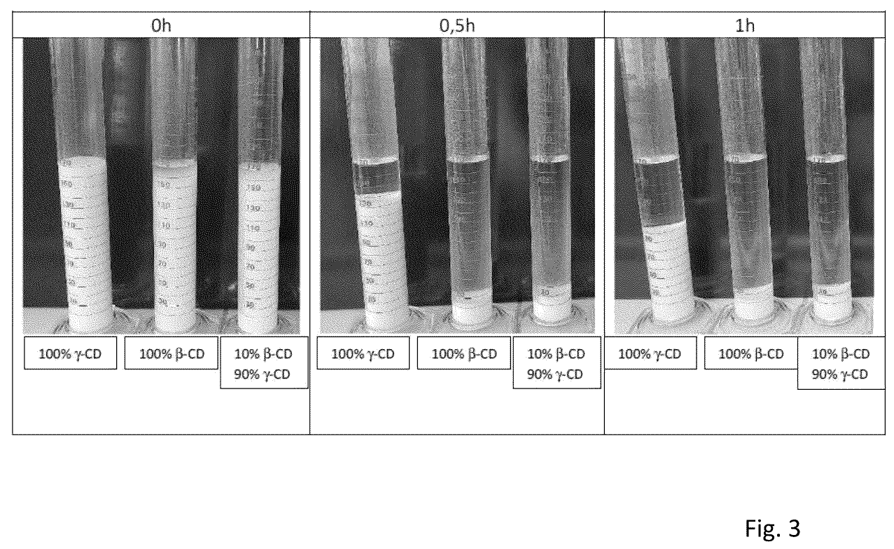

FIG. 3 shows three photographs, from left to right. They show pictures of a test arrangement consisting of three cylinders. The cylinders are filled with suspensions of cyclodextrin-AOS complexes. Each cylinder on the left contain complexes of gamma-cyclodextrin, each cylinder in the middle contains complexes of beta-cyclodextrin, each cylinder on the right contains complexes in a mixture (right) consisting of 10 wt % beta-and 90 wt % gamma-cyclodextrin, based on the total mass of cyclodextrin. In addition to these cyclodextrins, the suspensions shown contain ethanol-containing beer extract; each graduated cylinder contains 150 g of the beer extract and 9 g of the beta- or gamma-cyclodextrin or 9 g of the mixture of beta- and gamma-cyclodextrin. The suspensions were stirred for 48 hours at 6° C. in the presence of the different cyclodextrins or the cyclodextrin mixture and were then simultaneously transferred into the graduated cylinders.

After the start of the comparative experiment at time 0 h (left picture) the sedimentation of the particles from the suspensions can be seen over a duration of 0.5 h (middle picture) up to a duration of 1 h (right picture), showing that the particles from the suspension containing beta-cyclodextrin have already sedimented after 0.5 h and thus twice as fast as those from the suspension containing gamma-cyclodextrin, where a clear supernatant that is visually distinguishable from the sediment at the bottom of the cylinder only appears after a test duration of 1 h.

Surprisingly, the suspension with the mixture consisting of only 10 wt % beta-cyclodextrin and 90 wt % of gamma-cyclodextrin based on the total mass of cyclodextrin, i.e. predominantly gamma-cyclodextrin, shows the same visual impression of sedimentation behavior as the suspension containing beta-cyclodextrin alone as the cyclodextrin. Thus, according to the invention, an addition of beta-cyclodextrin to gamma-cyclodextrin in a ratio of less than 1:1 is sufficient to increase the settling rate of suspensions with gamma-cyclodextrin to values corresponding to the settling rate of suspensions with beta-cyclodextrin alone.

### EXEMPLARY EMBODIMENTS

### Example 1 for the Flavoring of, e.g., 0.0 vol % Alcohol Beers

An ethanol-containing (70 - 80 vol %) solid phase extract [1 kg with an aroma concentration of 4 g/l], which contains isoamyl alcohol, isoamyl acetate, phenylethyl alcohol, hexanoic acid, ethyl hexanoate and other aroma substances, is mixed with 60 g of α-, β-, and/or γ-cyclodextrin, preferably with γ-cyclodextrin. The mixture is stirred for 48 h at 6° C. The aromatic substance-cyclodextrin complex is separated by filtration and dried. To maximize yield, the ethanolic solid phase extract can again be mixed with α-, β-, and/or γ-cyclodextrin, preferably γ-cyclodextrin, namely 30 g per kg of solid phase extract. The alcohol-free filter cake obtained in this way is received in water and treated enzymatically to release the aromatic substance. For this purpose, the aqueous mixture is mixed with 111.1 amylase (Fungamyl® from Novozymes) per ml (1 microliter amylase per 1 milliliter of aqueous mixture) and is incubated in a closed vessel for 48 h at 55° C. and a pH of 5.2 (the maximum final cyclodextrin concentration is 0.1 wt % based on the total weight of the aqueous extract). The solubility of the extracted aroma components in water is low, which is why the resulting two-phase mixture can be homogenized with propylene glycol (up to 1:1 w/w), if necessary, and then filtered.

The so obtained alcohol-free product rich in aromatic substance (5 g/l) can now be used for the flavoring of beers, for example 0.0 vol % alcohol beers (application dosage: 0.2:1000).

In the context of the invention, the content of cyclodextrin and in particular the final cyclodextrin concentration in a composition is determined by HPLC (detector: RI; separation column: Polysep GFC-P 2000 from Phenomenex; eluent: 10% methanol in water (isocratic); flow: 0.5 ml/min; pressure: 25 bar; oven temperature: 55° C.; run time: 30 minutes).

The concentration of apolar organic substance, for example the concentration of aromatic substance, of the composition according to the invention, in particular of an alcohol-free extract, is determined by GC-FID (2 g samples were extracted with 2 g cyclohexane. The organic phase is dried over Na2SO4, admixed with internal standard, and analyzed).

### Example 2 for the Flavoring of, e.g., 0.0 vol % Alcohol Beers

A fermentate which contains isoamyl acetate or 4-vinylguaiacol is admixed with a molar equivalent of β-cyclodextrin (α- and/or γ-) with respect to the aromatic substance. In order to obtain a stable aromatic substance-cyclodextrin complex, the mixture is stirred for 48 h at 6° C.

The aromatic substance-cyclodextrin complex is separated by filtration or concentrated on the retentate side.

Release of the aromatic substance is achieved by an enzymatic treatment of the aromatic substance-cyclodextrin complex. For this purpose, the aqueous mixture was admixed with 111.1 amylase (Fungamyl® from Novozymes) per ml (1 microliter amylase per 1 milliliter of aqueous mixture) and was incubated in a closed vessel for 48 h at 55° C. and pH 5.2 (the maximum final cyclodextrin concentration is 0.1 wt % based on the total weight of the aqueous extract). The solubility of the extracted aroma components in water is low, which is why the resulting two-phase mixture can be homogenized with propylene glycol (up to 1:1 w/w) if necessary, and then filtered.

The so obtained alcohol-free product which is rich in aromatic substance can now be used for the flavoring of beers, for example in 0.0 vol % alcohol beers. The final cyclodextrin concentration is determined by HPLC (detector: RI; separation column: polysep GFC-P 2000 from Phenomenex; eluent: water (isocratic); flow: 0.8 ml/min; pressure: 20 bar; oven temperature: 55° C.; run time: 30 minutes). The aroma concentration of the alcohol-free extract is determined using GC-FID (2 g samples were extracted with 2 g cyclohexane. The organic phase is dried over Na₂SO₄, admixed with internal standard, and analyzed).

### Example 3 for the Flavoring of 0.0 vol % Alcohol Beverages

A solid phase extract containing ethanol (70-80 vol %) (or a spirit or liqueur (15-96 vol %)) containing isoamyl alcohol, isoamyl acetate, phenylethyl alcohol and other aromatic substances was mixed with 60 g/l of a mixture consisting of beta- and gamma-cyclodextrin (1:9). In order to obtain a sufficiently stable host-guest complex, the mixture was stirred overnight at 6° C. Subsequently, the mixture was allowed to rest for 2 hours for sedimentation (without beta-cyclodextrin, this process may take up to one day).

After sedimentation, the clear phase was removed and the sediment was dried by filtration.

For maximizing yield, the ethanolic clear solid phase extract depleted in aromatic substance can again be admixed with a beta- and gamma-cyclodextrin mixture (1:9) and then allowed to rest, having the clear phase removed after sedimentation, and then being subjected to filtration.

The alcohol-free filter cake obtained in this way was received in water and treated enzymatically to release the aromatic substance. For this purpose, the aqueous mixture was admixed with 1 μl amylase Dextrozyme GA (Novozymes) per milliliter and incubated in a closed vessel for 48 h at 55° C. and pH 4.5. Finally, the resulting mixture was filtered.

The so obtained alcohol-free product which is rich in aromatic substance can now be used in low doses, for example in a range from 0.01:1000 to 50:1000, for flavoring purposes, for example to flavor 0.0 vol % alcohol beers.

### Example 4 for the Extraction of Apple Wax-Containing Fraction from Dried Apple Pomace

1600 g of dry apple pomace was admixed with 8000 g of a 36 wt % aqueous cyclodextrin solution (beta-cyclodextrin to gamma-cyclodextrin in a 1:1 ratio, i.e. 18 g beta- and 18 g gamma-cyclodextrin to 1 liter of water), and was kneaded for 2 days at room temperature. The wet apple pomace was then filtered off, and the filtrate rich in cyclodextrin-apple wax complex was collected as a suspension.

As step (c) of the method according to the invention, the suspension was centrifuged, and the clear phase was decanted off

The so obtained extract (182.65 g) was admixed with 200 g of water and incubated with the amylase “Dextrozyme GA” (400 μl) for 48 h at a pH of 4.5 and 55° C. The mixture was then filtered off using vacuum, and was dried to constant weight on a rotary evaporator. The so obtained fraction rich in apple wax (16 g) was successfully tested as a constituent of a release agent for fruit gums, which means that the fraction rich in apple wax obtained in this way can be used as a release agent just as well as a release agent containing a wax (also apple wax) that was obtained through others previously known methods.

### Example 5 for the Extraction of Aroma-Containing Oil Fraction from Hop Cones

50 g of dry hop cones of the “Herkules” variety were mixed with 750 g of an 18 wt % aqueous solution of beta-cyclodextrin and kneaded at room temperature for 2 days. The wet hop cones were then filtered off, and the filtrate rich in cyclodextrin-oil complex was collected as a suspension.

As step (c) of the method according to the invention, the suspension was centrifuged and the clear phase was decanted off.

The so obtained extract (28.99 g) was admixed with 15 g of water and incubated with the amylase “Dextrozyme GA” (88 μl) for 48 h at a pH of 4.5 and 55° C. The aroma-rich extract obtained in this way has a high aroma load, allowing the extract obtained in this way to be used in a dosage of 1:1000 for flavoring, for example, alcohol-free beer.

### Example 6 for the Extraction of Aromatic Substances from Ethanol-Containing Gentian Root Extract

An extract of gentian roots with an alcohol content of 60 vol % was mixed with 6 wt % of gamma-cyclodextrin in solid form. The mixture was stored overnight at 6° C. In this way, sufficiently stable host—guest complexes were obtained.

The host-guest complex was separated by filtration as step (c) of the method according to the invention. Water was added to the filter cake. Release of the aromatic substances was achieved by enzymatic treatment of the host-guest complex. For this purpose, the aqueous mixture was admixed with 1 μl of the amylase “Dextrozyme GA” (Novozymes) per milliliter and incubated in a closed vessel for 48 h at 55° C. Finally, the resulting mixture was filtered.

The aroma-rich product obtained can now be used in low dosage for flavoring purposes, for example in products with an alcohol content of 0.0 vol % ethanol.

It will be apparent to a person skilled in the art that the invention is not limited to the examples described above, but rather can be varied in a variety of ways. The features of the individually illustrated examples can in particular also be combined with one another or interchanged with one another.

### LIST OF REFERENCE NUMERALS

1 Organic substance comprising at least one apolar group, for short: “apolar organic substance (AOS); aromatic substance, bitter substance, oil, fat, wax, adhesive, colorant

10 Starting mixture

2 Cyclodextrin

12 Guest—host complex of cyclodextrin and organic substance comprising at least one apolar group (AOS), cyclodextrin—AOS complex

20 Saccharides

3 Water

4 Ethanol-containing solution

40 Ethanol

5 Enzyme

6 Composition

1.-22. (canceled)

23. A method for flavoring and/or stabilizing a product which constitutes a food product, luxury food product, cosmetic product, or pharmaceutical product, comprising adding, to the product to be flavored, a composition (6) produced by a method for selectively separating at least one organic substance that comprises at least one apolar group (AOS) (1) and/or at least one or more aromatic substances;
wherein the method for selectively separating at least one organic substance comprising at least one apolar group (AOS) (1) and/or at least one or more aromatic substances comprises:
(a) providing a starting mixture (10) which contains at least one organic substance comprising at least one apolar group (AOS) and/or at least one or more aromatic substances (1);
(b) bringing the starting mixture (10) into contact with at least one cyclodextrin (2);
wherein at least one solvent is added in step (a) and/or in step (b) and/or following step (b);
and wherein, as a result of the contacting of the at least one cyclodextrin (2) with the at least one organic substance comprising at least one apolar group and/or the at least one or more aromatic substances (1) of the starting mixture (10), at least one cyclodextrin-AOS complex and/or cyclodextrin-aromatic substance complex (12) is obtained in a liquid phase (3; 4);
(c) separating the cyclodextrin-AOS complex and/or the cyclodextrin-aromatic substance complex (12) from the liquid phase; and
(d) enzymatically treating the separated cyclodextrin-AOS complex and/or the cyclodextrin-aromatic substance complex (12) to obtain a composition (6) that is loaded with at least one organic substance comprising at least one apolar group (AOS) (1) and/or with at least one aromatic substance;
wherein the enzymatic treatment is performed using at least one enzyme selected from the group consisting of enzymes with amylase activity, debranching enzymes, and mixtures thereof.

24. A composition, produced by a method for selectively separating at least one organic substance that comprises at least one apolar group (AOS) (1) and/or at least one or more aromatic substances;
for introducing at least one aromatic substance and/or at least one organic substance (1) comprising at least one apolar group, selected from the group consisting of volatile aromatic substances, non-volatile aromatic substances, oil, fat and/or wax fractions, colorants, and adhesives, and mixtures thereof;
into a food, luxury food, cosmetic product, or pharmaceutical product, using the method for selectively separating at least one organic substance comprising at least one apolar group (AOS) (1) and/or at least one or more aromatic substances comprises:
(a) providing a starting mixture (10) which contains at least one organic substance comprising at least one apolar group (AOS) and/or at least one or more aromatic substances (1);
(b) bringing the starting mixture (10) into contact with at least one cyclodextrin (2); wherein at least one solvent is added in step (a) and/or in step (b) and/or following step (b); and wherein, as a result of the contacting of the at least one cyclodextrin (2) with the at least one organic substance comprising at least one apolar group and/or the at least one or more aromatic substances (1) of the starting mixture (10), at least one cyclodextrin-AOS complex and/or cyclodextrin-aromatic substance complex (12) is obtained in a liquid phase (3; 4);
(c) separating the cyclodextrin-AOS complex and/or the cyclodextrin-aromatic substance complex (12) from the liquid phase; and
(d) enzymatically treating the separated cyclodextrin-AOS complex and/or the cyclodextrin-aromatic substance complex (12) to obtain a composition (6) that is loaded with at least one organic substance comprising at least one apolar group (AOS) (1) and/or with at least one aromatic substance;
wherein the enzymatic treatment is performed using at least one enzyme selected from the group consisting of enzymes with amylase activity, debranching enzymes, and mixtures thereof.

25. The method of claim 23, wherein
the at least one organic substance (1) comprising at least one apolar group is selected from the group consisting of volatile aromatic substances, non-volatile aromatic substances, oil, fat and/or wax fractions, colorants, adhesives, and mixtures thereof

26. The method of claim 23,
wherein
in step (a) and/or in step (b) and/or following step (b),
a water content in the range from 15 vol % to 35 vol % is adjusted;
and/or an ethanol content is adjusted so as to be at least 40 vol %.

27. The method of claim 23,
comprising a further step of
(d1) diluting the cyclodextrin-AOS complex separated in step c) and/or the cyclodextrin-aromatic substance complex (12) with water prior to the treatment in step d).

28. The method of claim 23,
wherein
step (d) is performed such that a cyclodextrin concentration in the composition (6) that is loaded with at least one apolar organic substance (AOS) and/or with at least one aromatic substance (1) is less than 0.5 wt %.

29. The method as claimed in claim 23, comprising a further step of
(e) filtering the mixture resulting from the enzymatic treatment of the cyclodextrin-AOS complex and/or the cyclodextrin-aromatic substance complex (12), wherein a composition (6) loaded with at least one organic substance comprising at least one apolar group (AOS) and/or with at least one aromatic substance is obtained.

30. The method as claimed in claim 23,
wherein in step (a) and/or in step (b) and/or following step (b) at least one solvent is used,
which solvent is selected from the group consisting of water, C₁-C₄ alcohols, diethyl ether, acetone, and mixtures thereof.

31. The method as claimed in claim 23,
wherein as a cyclodextrin (2), at least one substituted or unsubstituted α-cyclodextrin, at least one substituted or unsubstituted β-cyclodextrin, at least one substituted or unsubstituted γ-cyclodextrin, at least one substituted or unsubstituted δ-cyclodextrin, or mixtures thereof is used.

32. The method as claimed in claim 23,
wherein the separating of the cyclodextrin-AOS complex (12) in step (c) is carried out by centrifugation or filtration.

33. The method as claimed in claim 23,
comprising a further step of
(c1) allowing to rest, prior to the separating of the cyclodextrin-AOS complex and/or the cyclodextrin-aromatic substance complex from the liquid phase;
wherein the resting phase according to step (c1) is performed over a duration of up to 24 hours.

34. The method as claimed in claim 23,
wherein the separated liquid phase as obtained in step (c) by separating the cyclodextrin-AOS complex and/or the cyclodextrin-aromatic substance complex (12) is admixed again with at least one cyclodextrin (2), and is recirculated to step (a), to maximize yield.

35. The method as claimed in claim 23,
wherein the cyclodextrin-AOS complex and/or the cyclodextrin-aromatic substance complex (12) separated in step (c) is prior to the enzymatic treatment in step (d), diluted in a step (d1) with water, so as to obtain a desired final concentration of one or more hydrophilic organic substances and/or one or more aromatic substances (1).

36. The method as claimed in claim 23,
wherein the enzymatic treatment in step (d) is performed using at least one enzyme (5) selected from the group consisting of alpha-amylase, pulluanase, isoamylase, and mixtures thereof.

37. The method as claimed in claim 23,
wherein the at least one enzyme (5) is used in an amount ranging from 5 FAU to 1000 FAU per gram of the separated solid phase.

38. A method, comprising:
using the composition according to claim 24 for introducing at least one aromatic substance and/or at least one organic substance (1) comprising at least one apolar group into a food or a luxury food or a beverage or a cosmetic product or a pharmaceutical product with an ethanol content of 0.0 vol %.
